(19) United States
(12) Patent Application Publication
(10) Pub. No.: US 2010/0174574 A1
(43) Pub. Date: Jul. 8, 2010

(54) Intelligent submittal management related applications

(76) Inventor: Elbert Harris, Leewood, KS (US)

Correspondence Address: Entrepreneurial Studies and Development, UCM Dockery Suite 102, Warrensburg, MO, 64093, US

(21) Appl. No.: 12/592,745

(22) Filed: Dec. 2, 2009

Related U.S. Application Data
(60) Provisional application No. 61/200,804, filed on Dec. 4, 2008.

(51) Int. Cl. G06Q 10/00; G06F 17/30

(52) U.S. Cl. 705/7; 707/802; 707/E17.044

(57) ABSTRACT

A computer implemented method for managing construction submittal requirements for a construction project. The method provides a first database containing information related to managing a construction project having stored therein a plurality of requirements for the construction project.
providing a computer network including a plurality of user computer access points;
providing a second database containing submittals having information about a contractors execution of said requirements;
providing a computer implemented rule set;
applying the rule set to said submittals in said second database and automatically flagging information in said submittal that fails to satisfy the rule set.

### RELATED APPLICATIONS

This application claims priority under 35 USC 119 to provisional patent application 61/200,804 of the same title filed Dec. 4, 2008.

### BACKGROUND OF THE INVENTION

In the construction industry it is desirable to effectively manage construction projects. In construction a general or prime contractor, herein after general contractor, must manage a variety of ongoing projects. Overlapping the projects is the need to manage relationships with many individuals including project owners, architects, sub-contractors, material suppliers and inspectors.

One of the critical functions in a construction project is to manage the submittal of information and materials to meet specifications. In almost all construction projects it is typical for the architect and engineering design firms to determine a project design and to set the specifications for materials to meet the design parameters. Once the specifications are set, contractors and subcontractors working on the project must make submittals of material specifications to meet the requirements set. A big job for those involved with a construction project is to manage these submittals and to receive timely approvals to requests to keep a construction project moving forward.

In today's construction environment large fines and penalties can be exacted against entities that fail to act in a timely and efficient manner. These fines can lead to litigation associated with when submittals were made and who is responsible for delays. In many cases stacks of files and paperwork must be stored for years by each entity involved with a project to create a paperwork trail of what happened when. With fines and the threat of litigation, documentation has become a critical element for the contractor who plans to succeed in managing construction projects. It is also common place for professional time to be wasted in considering submittal documents that are not in compliance.

As can be seen there is a need for a system that allows the range of construction professionals to be involved in the management of submittals and the efficient consideration and handling of submittals for approval.

### SUMMARY OF THE INVENTION

The present invention relates to a networked system that brings together the various professionals and suppliers that might be involved in creating, managing and storing the plurality of material specification submittals associated with a construction project. The system provides for network access to the system for those professionals that might need it. The system provides for rapid detection of submittals that are out of compliance so that the time of professionals is saved and so that out of compliance items can be detected rapidly to prevent project delay whenever possible.

These and other advantages of the present invention will become apparent from the detailed description of the invention.

### BRIEF DESCRIPTION OF THE DRAWINGS

FIG. 1 shows a flow chart of the submittal management system.

### DETAILED DESCRIPTION OF THE DEVICE

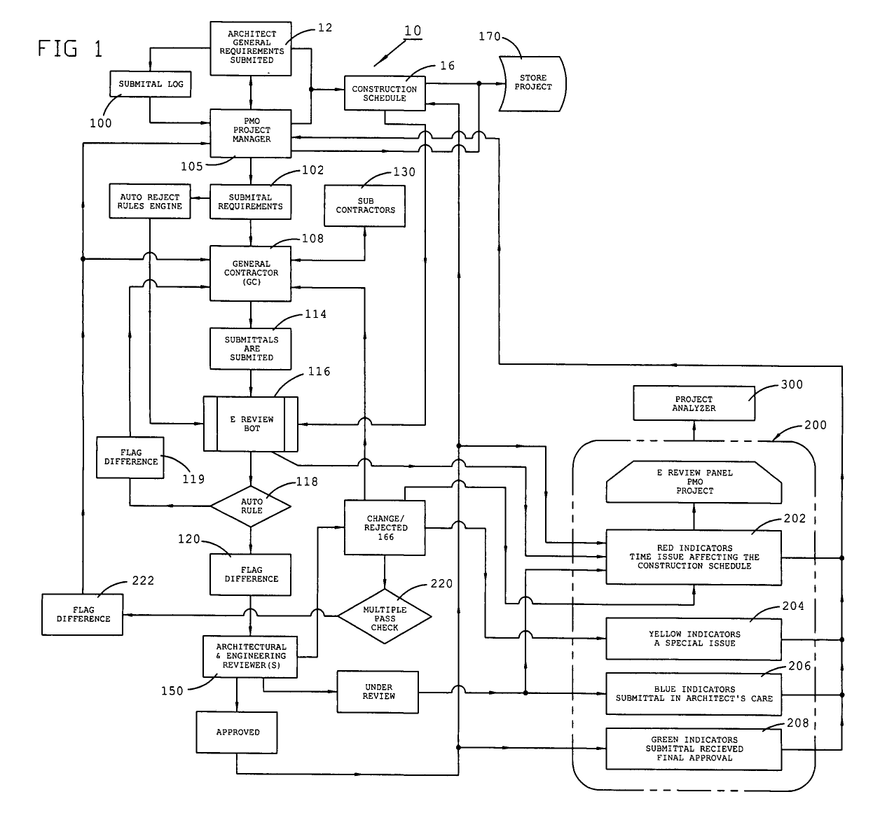

FIG. 1 shows a flow chart of the system 10 for submittal process management, the flow chart of FIG. 1 tracks a single submittal requirement through the system 10. The system 10 begins with an architect developed project plan 12, and a general contractor has bid on and received the contract to build a project. The initial step in the submittal process can be for the architect to send the general contractor the submittal log 100. The submittal log 100 contains all the requirements and specifications that must be met by various components used in a construction project. For a multi-story building the submittal log 100 will contain thousands of requirements for the total building, typical submittal requirements might be for the color of paint or for the energy efficiency of a window for example. The submittal log 100 along with project prints, specifications and other contract documents can be transferred electronically to the project manager 105 who might also be the general contractor, who can make those documents available to project professionals selectively through an Internet site or via email for example.

After the project manager 105 receives the submittal log 100, the requirements will be divided up 102 and stored in a network accessible database. A construction schedule 16 can also be created and made available. The requirements are generally divided along the lines of trades such as plumbing, structural, electrical, heating and ventilating and so forth. The project is then forwarded from the general contractor 108 to a computer network such as the Internet so that the subcontractors 130 of the various trades can begin to download the submittal requirements for their portion of the project.

Submittals will then be submitted 114 from the contractors to the architect, project manager, general contractor or project owner. The submittals are sent through an e-review Bot 116 that will look at a set of automated rules 118. If certain rules are not met the auto rules will reject the submittal and flag differences 119 and return the submittal to the general contractor 108. If a submittal is returned a red indicator 202 is created within the e-review panel 200. Red indicators 202 indicate a submittal has been rejected that might cause a critical delay to the project schedule, an email might be sent to the general contractor to indicate a rejected submittal. If the submittal passes the auto rules screening the e-review bot 116 will then flag any minor differences between the rules and the submittal and send it on to the architectural and engineering review 150.

Once the submittal reaches the architect/engineer review it still might be rejected 166 which would cause a yellow indictor 204. Again an email can be sent to the contractor to indicate that the submittal passed the initial screening but was still rejected later. If a submittal has passed the initial bot review 116 but is still under architect engineer review 162 a blue indicator 206 is lit indicating a submittal that has not been accepted or rejected. Finally if a submittal is approved 164 then a green indicator 208 is activated and a message is sent to the contractor indicating acceptance of the submittal.

The reason for the colored indicators in panel 200 is to create a visual display of information. For example, an architect could look at an entire project and see where all the red indicators were indicating areas that may cause project delay. The information from the panel 200 can also be shared with a project analyzer 300 that will consider information from multiple projects for example, a general contractor could look at the performance of each of his contractors over a number of different projects and get an indication of the performance of that sub-contractor. For example, one sub-contractor might have a history of having more red indictors and that might influence how the general contractor looked at future bids from that sub. Also the analyzer 300 might actually prevent a sub contractor from bidding at all on a new project if they have too many red or yellow flags on existing submittals.

If a submittal is rejected 166 more than once a multiple pass check 220 triggers a project compliance status report 222 to be sent to the general contractor. Once a project is complete the entire project and history can be stored 170 such as on a computer accessible through the Internet and on the projects analyzer 300.

The e-review bot 116 will contain rules set based initially of industry standards. For example, in most construction applications a submittal containing the wrong color paint would be an automatic reject and would be flagged as the wrong color and returned to the submitting contractor as an error. This rejection would not require any time from the architect or building owner. But in some construction applications the color of paint might not be an important issue and so the architect might want to go into the bot 116 and reprogram the rules to not reject based on the color of paint. Reprogramming of the Bot 116 can occur at any level from the supplier of the bot 116 to the architects who finally use it. There may be versions that would be programmed and marked through certain trade associations that would focus on a specific type of construction such as multi-family dwellings or nuclear power plants which are likely to have different rules. Also the user can set a level of acceptance in the bot 116 so for example a contractor might elect to look at all submittals that contain one error but to reject all submittals that contain more than one error. This allows the user to optimize the time and effort savings of the system.

1. A computer implemented method for managing submittal requirements for a construction project said method comprising the steps of;
providing a first database containing information related to managing a construction project having stored therein a plurality of requirements for the construction project;
providing a computer network including a plurality of user computer access points;
providing a second database containing submittals having information about a contractor's execution of said requirements;
providing a computer implemented rule set;
applying said computer implemented rule set to said submittals in said second database and automatically flagging information in said submittal that fails to satisfy said rule set, rejecting a submittal based on said flagged information.

2. The computer implemented method of claim 1 wherein said flagged information is stored on the Internet and is accessible to a project owner via the Internet.

3. The computer implemented method of claim 1 wherein said step of rejecting said submittal includes analyzing a delay caused by said rejection and sending a notification if said rejection causes a project delay.

4. The computer implemented method of claim 2 wherein said method includes the step of creating a file indicative of a contractors historical performance on contract submittals and using the file to select a contractor for a future project.

5. The computer implemented method of claim 2 including the step of providing a color codes display indicating potential project delays based on rejected submittals.

6. A computer implemented method for managing submittal requirements for a construction project said method comprising the steps of;
providing a first set of data containing submittal information related to a construction project having stored therein a plurality of requirements for the construction project;
providing a second set of data containing submittals having information about a contractor's execution of said requirements;
providing a computer implemented rule set;
to applying said computer implemented rule set to said submittals in said second database and automatically flagging information in said submittal that fails to satisfy said rule set, automatically choosing either one of accepting or rejecting a submittal based on said flagged information.

7. The computer implemented method of claim 6 wherein said flagged information is stored on the Internet and is accessible to a project owner via the Internet.

8. The computer implemented method of claim 6 wherein said step of accepting or rejecting said submittal includes analyzing a delay caused by said rejection and sending a notification if said rejection causes a project delay.

9. The computer implemented method of claim 6 wherein said method includes the step of creating a file indicative of a contractors historical performance on contract submittals and using the file to select a contractor.

10. The computer implemented method of claim 6 including the step of providing a coded display indicating potential project delays based on said flagged information.

11. A computer implemented method for managing submittal requirements for a construction project said method comprising the steps of;
providing a first set of data containing submittal information related to a construction project having stored therein a plurality of requirements for the construction project;
storing a second set of data containing submittals having information about a contractor's execution of said requirements;
providing a computer implemented rule set;
applying said computer implemented rule set to said submittals in said second database and automatically flagging information in said submittal that fails to satisfy said rule set, automatically choosing either one of accepting or rejecting a submittal based on said flagged information satisfying said rule set.

12. The computer implemented method of claim 11 wherein said method includes the step of creating a file indicative of a contractor's historical performance on contract submittals and using the file to manage a construction project.

13. The computer implemented method of claim 12 wherein said flagged information is stored on a computer network.

14. The computer implemented method of claim 13 wherein said step of accepting or rejecting said submittal includes sending a notification if said rejection causes a project delay.

15. The computer implemented method of claim 13 including the step of providing a color coded display indicating potential project delays based on said flagged information.
